(19) United States
(12) Patent Application Publication
(10) Pub. No.: US 2005/0206794 A1
(43) Pub. Date: Sep. 22, 2005

(54) Television receiver having reinforcement/mounting dual - purpose structure

(75) Inventor: Takashi Tokuda, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/079,104

(22) Filed: Mar. 15, 2005

(30) Foreign Application Priority Data
Mar. 16, 2004 (JP) 2004-074153

(51) Int. Cl. H04N 5/64

(52) U.S. Cl. 348/836

(57) ABSTRACT

A television receiver having a reinforcement/mounting dual-purpose structure is provided by forming reinforcement ribs and boss sections beforehand in an area of a flat vertical inner wall surface of a cabinet so that the boss sections intended to function as a reinforcement structure allow parts and devices such as operation buttons to be retrofitted to the boss sections according to applications and can also be used as a mounting structure for mounting the parts. Reinforcement ribs 11 and boss sections 12 for further reinforcing the reinforcement ribs 11 are formed integral with a flat vertical inner wall surface 10 of a cabinet which forms the outer shape of a television receiver 1. Mounting holes 12A are formed in the boss sections 12 to allow operation buttons 20 to be retrofitted thereto, the boss sections 12 and reinforcement ribs 11 are used as a reinforcement structure for the cabinet when the operation buttons 20 are not attached to the cabinet and the boss sections 12 are used as a mounting structure for attaching the operation buttons 20 when the operation buttons 20 are attached to the cabinet. In this way, it is possible to provide a television receiver having a reinforcement/mounting dual-purpose structure 1 with excellent versatility.

The present application is based on and claims priority of Japanese patent application No. 2004-074153 filed on Mar. 16, 2004, the entire contents of which are hereby incorporated by reference.

### BACKGROUND OF THE INVENTION

1. Field of the Invention

The present invention relates to a television receiver provided with an image display device and the like, and more particularly, to a television receiver having a reinforcement/mounting dual-purpose structure which serves as a reinforcement rib, a boss section, and the like, formed on a cabinet inner wall surface of this television receiver and at the same time allows various parts and the like to be attached to the reinforcement rib and boss section according to applications.

2. Description of the Related Art

One of consumers' demands for a television receiver in recent years is a television receiver having multi-functions capable of recording/reproducing a recording medium such as optical disk like DVD (Digital Video Disc) or CD (Compact Disc). In response to such consumers' demand, television receivers having composite functions are supplied to consumers. On the other hand, consumers are also demanding for compactness in appearance of a television receiver.

FIG. 8 is a rear view of a front cabinet 102 of a television receiver 101 whose exterior is formed of the front cabinet 102 and a rear cabinet which is conventionally used. In such a television receiver 101, when there is a completely empty area on a vertical inner wall surface 10 of the front cabinet as shown with an ellipse of a single-dot dashed line in FIG. 8, such a vertical inner wall surface 10 is weaker in strength than a vertical inner wall surface throughout which reinforcement ribs are formed. For example, when the television receiver 101 having the front cabinet 102 including such a completely empty area is transported by a vehicle and the like, shocks and vibration caused by driving of the vehicle or weight of a relatively heavy image display device among components of the television receiver 101 such as a cathode ray tube and liquid crystal display device attached to the front cabinet 102 and vibration during transportation and the like may cause distortion or displacement in the front cabinet 102 and the like. On the other hand, when various components and devices are additionally attached to the vertical inner wall surface 110 placed upright in the cabinet of the existing television receiver 101, no means for mounting these components is formed in the front cabinet 102 and the like of the television receiver 101 beforehand, and therefore, it is necessary to additionally mold the cabinet by providing a nest and the like in a metal die on the core side to mount the various components. Furthermore, Japanese Patent Laid-Open Publication No. 2000-299567 (Patent Document 1) discloses amounting structure for push buttons arranged in the operation section of a television receiver with ribs formed integral with the inner surface of the cabinet which is a housing of the television receiver.

However, in the case of the above described related art, when parts and devices such as operation buttons and a hard disk drive are attached to the vertical inner wall surface placed upright in the cabinet of the television receiver and not only by simply placing those parts and devices on the bottom of the television receiver, it is necessary to form some additional mounting means in the front cabinet, which leads to an increase in cost for creating a die to respond to the corresponding design modification. In other words, re-design involves additional cost, making it impossible to decrease manufacturing cost.

### SUMMARY OF THE INVENTION

The present invention has been implemented in view of such problems and it aims at providing a television receiver having a reinforcement/mounting dual-purpose structure realized by forming reinforcement ribs and boss sections beforehand in a completely empty flat area of a vertical inner wall surface placed upright in a cabinet of the television receiver, capable of not only providing boss sections having the function as a reinforcement structure but also providing a mounting structure which allows parts and devices such as operation buttons to be retrofitted to this boss sections according to applications.

The television receiver having a reinforcement/mounting dual-purpose structure according to the first aspect of the invention is a television receiver provided with convex reinforcement ribs formed integral with a flat vertical inner wall surface of a cabinet which forms an outer shape of the television receiver, having a reinforcement/mounting dual-purpose structure comprising cylindrical boss sections protruding from the vertical inner wall surface integral with the reinforcement ribs for reinforcing the reinforcement ribs, and mounting holes formed in the boss sections so as to allow parts to be provided for the television receiver to be attached thereto, using the boss sections and the reinforcement ribs as a reinforcement structure for the cabinet when the parts are not attached to the cabinet and using the boss sections as a mounting structure to attach the parts when the parts are attached to the cabinet.

According to the arrangement of the first aspect of the invention, the vertical inner wall surface of the cabinet is provided with the reinforcement ribs and the cylindrical boss sections for further reinforcing the reinforcement ribs, and therefore, for example, when the television receiver is transported by a vehicle or when the television receiver is mistakenly dropped on to the ground, it is possible to prevent the cabinet from bending, being broken or distorted. On the other hand, when parts and devices need to be additionally attached inside the television receiver, since mounting holes are formed in the boss sections to further reinforce the reinforcement ribs, it is possible to attach parts to the mounting holes, and even when parts need to be additionally attached to the television receiver, it is possible to attach the parts to the vertical inner wall surface of the cabinet. Furthermore, when parts need to be additionally attached to the vertical inner wall surface of the cabinet, it is possible to use the boss sections 12 in which mounting holes 12A are formed as a mounting structure used to attach parts such as operation buttons 20 without additionally mold and prepare a cabinet for which mounting means such as the boss sections is molded integral with the vertical inner wall surface of the cabinet as in the case of the conventional method, and it is thereby possible to provide a television receiver having a reinforcement/mounting dual-purpose structure with excellent versatility.

The television receiver having a reinforcement/mounting dual-purpose structure according to the second aspect of the invention is the television receiver having a reinforcement/mounting dual-purpose structure according to the first aspect of the invention, wherein the parts are operation buttons which are attached to the mounting holes of the boss sections with one end of each operation button inserted into an opening formed in the cabinet for enabling various operations of the television receiver.

According to the arrangement of the second aspect of the invention, when operation buttons need to be additionally attached to the television receiver, it is possible to attach the operation buttons to the mounting holes of the boss sections formed on the vertical inner wall surface of the cabinet by fitting or screwing mounting means such as screws into the mounting holes, and since one end of each operation button is inserted into the opening formed in the cabinet, the user of the television receiver can easily operate the television receiver from the outer side.

The television receiver having a reinforcement/mounting dual-purpose structure according to the third aspect of the invention is the television receiver having a reinforcement/mounting dual-purpose structure according to the second aspect of the invention, wherein the operation buttons are attached to the mounting holes formed in the boss sections by screwing screws into the mounting holes.

According to the arrangement of the third aspect of the invention, the use of versatile, easy-to-use screws facilitates the attaching of the operation buttons to the mounting holes by screwing screws, making it possible to perform mounting work efficiently.

The television receiver having a reinforcement/mounting dual-purpose structure according to the fourth aspect of the invention is the television receiver having a reinforcement/mounting dual-purpose structure according to any one of the first to the third aspect of the invention, wherein the cabinet is made up of a front cabinet and a rear cabinet, in which the front cabinet is provided with an image display device and the boss sections with the reinforcement ribs formed integral with the front cabinet.

According to the structure of the fourth aspect of the invention, the image display device is a main device among parts and devices constituting the television receiver and is relatively heavy. When such a heavy image display device is placed in the front cabinet, a large load is imposed on the front cabinet. In such a state, the boss sections for reinforcing the reinforcement ribs are further formed in addition to the general reinforcement ribs on the vertical inner wall surface of the front cabinet, and therefore, it is possible to reduce distortion of the front cabinet being produced when the image display device is provided in the front cabinet.

The television receiver having a reinforcement/mounting dual-purpose structure according to the first aspect of the invention is a television receiver provided with convex reinforcement ribs formed integral with a flat vertical inner wall surface of a cabinet which forms the outer shape of the television receiver, wherein the cylindrical boss sections protruding from the vertical inner wall surface integral with the reinforcement ribs for reinforcing the reinforcement ribs are formed, and mounting holes are formed so that parts to be provided for the television receiver can be attached to these boss sections using the boss sections and the reinforcement ribs as a reinforcement structure for the cabinet when the parts are not attached to the cabinet and using the boss sections as a mounting structure to attach the parts when the parts are attached to the cabinet. In addition, even when external shock or load is applied to the cabinet, it is possible to prevent the cabinet from bending or being distorted. Furthermore, it is possible to further reinforce the reinforcement ribs as the reinforcement structure for the pre-molded cabinet using the boss sections and also use this reinforcement structure as the mounting structure capable of attaching parts to the mounting holes formed in these boss sections according to applications. Therefore, it is possible to provide a television receiver having a reinforcement/mounting dual-purpose structure with excellent versatility.

The television receiver having a reinforcement/mounting dual-purpose structure according to the second aspect of the invention is the television-receiver having a reinforcement/mounting dual-purpose structure according to the first aspect of the invention, wherein the parts are operation buttons which are attached to the mounting holes of the boss sections with one end of each operation button inserted into an opening formed in the cabinet for enabling various operations of the television receiver. In addition, even when parts and devices such as operation buttons need to be additionally attached to the television receiver, it is possible to attach the operation buttons into the mounting holes. Since one end of each operation button is inserted into the opening formed in the cabinet, the user of the television receiver can easily operate the television receiver from the outer side, which facilitates operations of the operation buttons and provides excellent operability.

The television receiver having a reinforcement/mounting dual-purpose structure according to the third aspect of the invention is the television receiver having a reinforcement/mounting dual-purpose structure according to the second aspect of the invention which comprises the operation buttons which are attached to the mounting holes formed in the boss sections by screwing screws into the mounting holes. According to this arrangement, it is possible to easily attach the operation buttons using general-purpose screws, which avoids complicated operation and facilitates the mounting operation, thus improving operability and also improving production efficiency.

The television receiver having a reinforcement/mounting dual-purpose structure according to the fourth aspect of the invention is the television receiver having a reinforcement/mounting dual-purpose structure according to any one of the first to the third aspect of the invention which comprises the cabinet made up of a front cabinet and a rear cabinet, in which the front cabinet is provided with an image display device and the boss sections with the reinforcement ribs formed integral with the front cabinet, and even when the weight of the image display device provided in the front cabinet is imposed on the front cabinet a great deal, the boss sections and reinforcement ribs formed integral with the front cabinet can prevent the front cabinet from being broken or distorted, providing a television receiver resistant to weight and with excellent strength.

### BRIEF DESCRIPTION OF THE DRAWINGS

FIG. 1 is front view of a television receiver according to the present embodiment;

FIG. 2 is an enlarged perspective view of main parts of a front cabinet of the television receiver according to the present embodiment;

FIG. 3 is an enlarged rear view of the front cabinet of the television receiver according to the present embodiment;

FIG. 4 is an enlarged rear view of main parts of the front cabinet showing the operation buttons attached to the boss sections according to the present embodiment;

FIG. 5 is an enlarged cross-sectional view of main parts of the front cabinet showing the operation buttons attached to the boss sections according to the present embodiment;

FIG. 6 is a front view of the operation buttons according to the present embodiment;

FIG. 7 is a rear view of the operation buttons according to the present embodiment; and

FIG. 8 is a rear view of a front cabinet of a television receiver used in a conventional example.

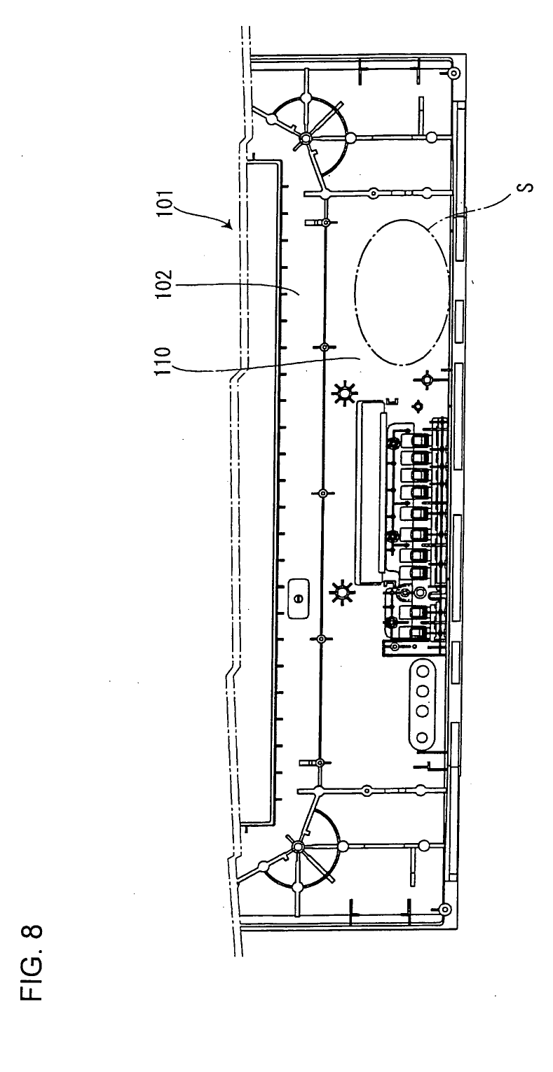

### DETAILED DESCRIPTION OF THE PREFERRED EMBODIMENTS

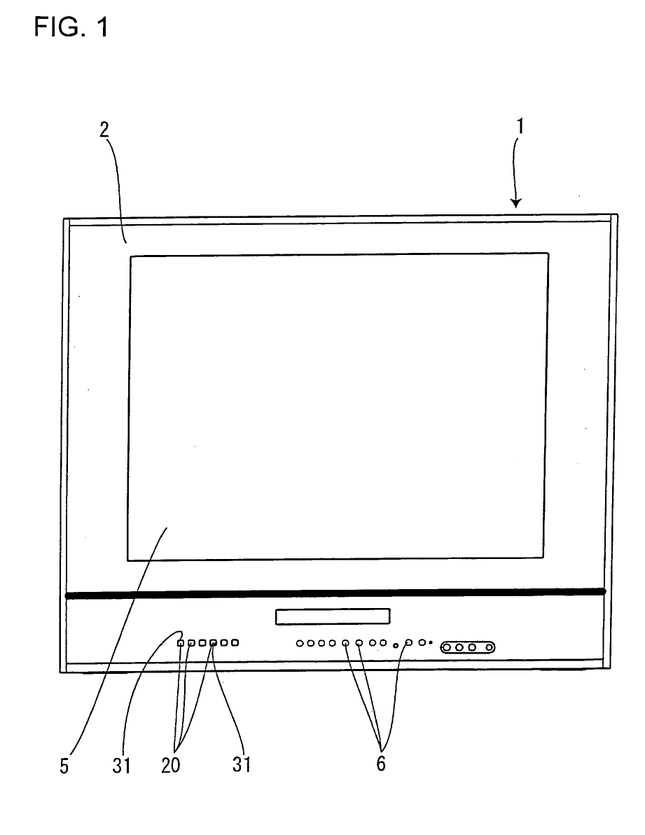

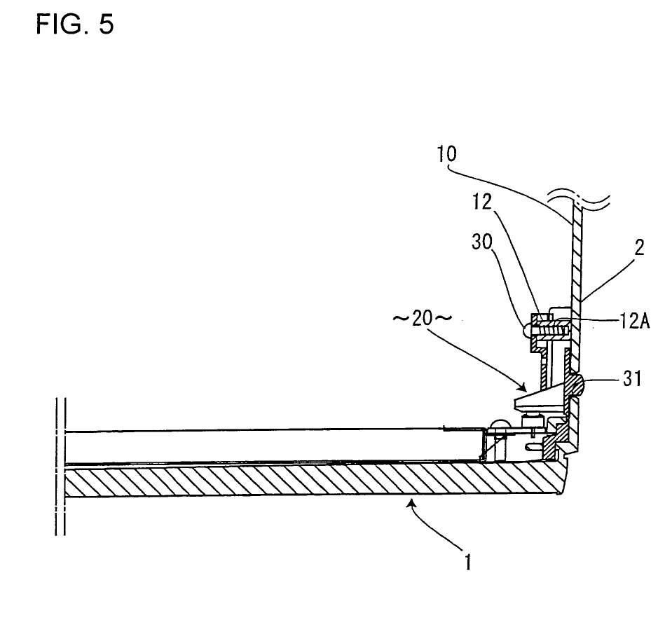

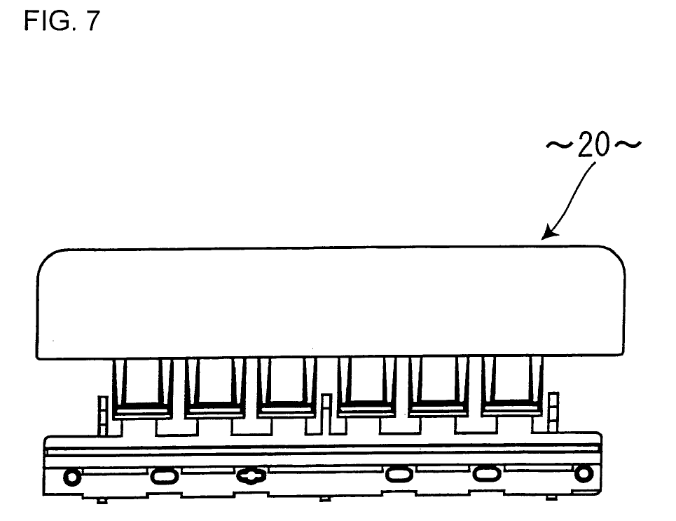

With reference now to FIGS. 1 to 7, one preferred embodiment of the present invention will be explained below. Please note that the following embodiment is a mere example for embodying the invention and is not intended to limit the invention within the scopes of the embodiment.

FIG. 1 is a front view of a television receiver having a reinforcement/mounting dual-purpose structure. The television receiver having a reinforcement/mounting dual-purpose structure (hereinafter referred to as “television receiver”) 1 has an exterior formed of a cabinet made of synthetic resin and this cabinet is made up of a front cabinet 2 which is divisible into front and back portions and a rear cabinet 3. Furthermore, an opening is formed in the front center of the front cabinet 2 and this opening is provided with an image display device 5 to display an image. Operation buttons 6 which allow various operations of the television receiver 1 such as volume adjustment are provided below the image display device 5 of the front cabinet 2 and a circuit board and tuner device (not shown) and the like, are placed and attached to the bottom of the television receiver 1.

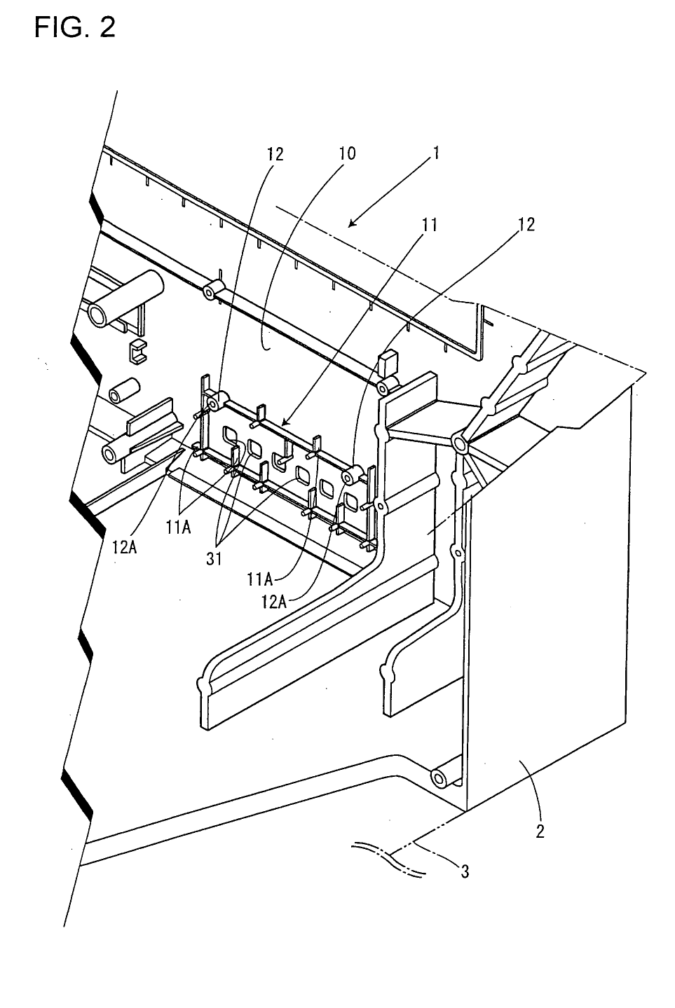

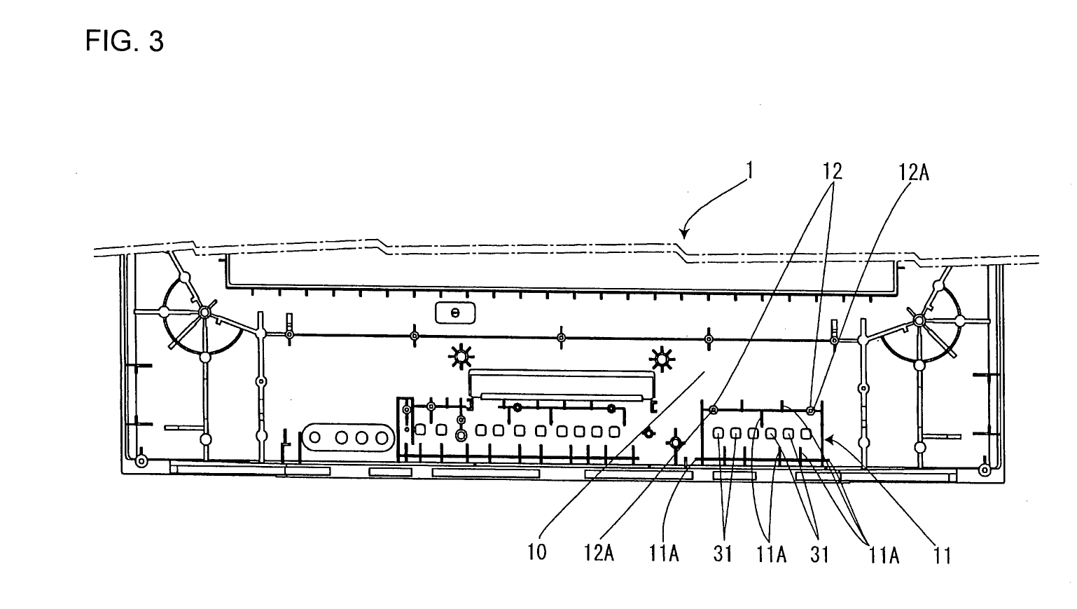

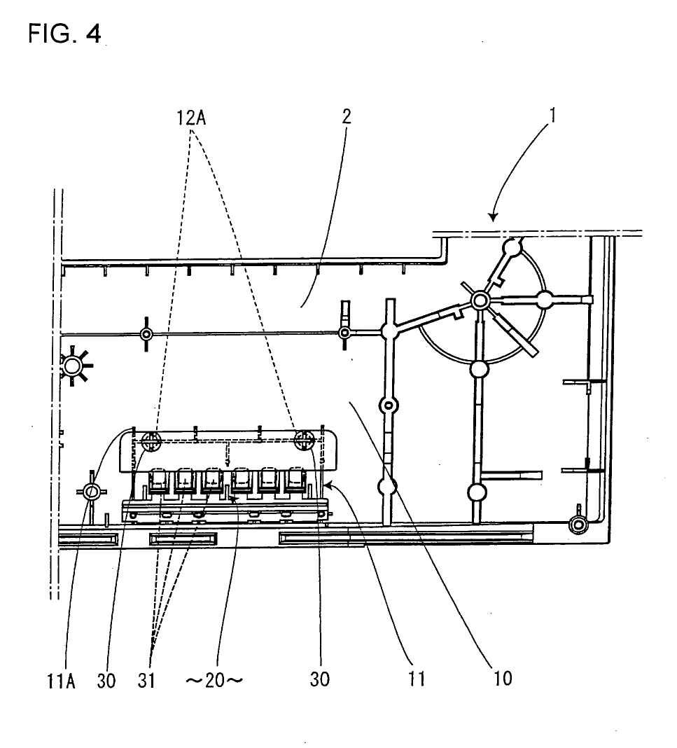

Furthermore, reinforcement ribs 11 are formed integral with substantially an entire flat vertical inner wall surface 10 placed upright in the vertical direction in the cabinet such as the front cabinet 2 except areas where various parts such as the operation buttons 20 are provided as shown in FIG. 4. The reinforcement ribs 11 protrude from the vertical inner wall surface 10 of the front cabinet 2 in a convex form and the overall shape of the reinforcement ribs 11 is at least rectangular as shown in FIG. 2 and FIG. 3 and the rectangle-shaped reinforcement ribs 11 have extensions 11A extending from the reinforcement ribs 11 in the vertical and horizontal directions, and in this way, the reinforcement ribs 11 are formed as an integral part. Furthermore, boss sections 12 are formed near upper corners of the rectangle of the reinforcement ribs 11 for further strongly reinforcing the reinforcement ribs 11, integral with the reinforcement ribs 11 and also integral with the vertical inner wall surface 10. The boss sections 12 protrude from the vertical inner wall surface 10 and the vertical inner wall surface 10 and the reinforcement ribs 11 are thereby formed as one body. The overall outer shape of the boss section 12 is cylindrical and a mounting hole 12A which penetrates the boss section 12 in the axial direction is formed in the center thereof, in other words, the boss section 12 has a cylindrical doughnut shape. The mounting holes 12A are used to attach parts and devices provided inside the television receiver 1 and screwing screws and the like into the mounting holes 12A provides a mounting structure which allows parts and devices such as operation buttons, which will be described later, to be attached, and forming the boss sections 12 in which the mounting holes 12A are formed integral with the reinforcement ribs 11 also provides the function as a reinforcement structure for reinforcing the reinforcement ribs 11 more strongly. At the positions at which the boss sections 12 and reinforcement ribs 11 are formed as one body and connected together, the width of the boss sections 12 is greater than the width of the connected portions of the reinforcement ribs 11. Furthermore, the front cabinet 2 above the reinforcement ribs 11 and boss sections 12 is provided with the image display device 5 such as a cathode ray tube or liquid crystal display device having relatively large weight among parts and devices constituting the television receiver 1, and the reinforcement ribs 11 and boss sections 12 support the weight of the heavy image display device 5 applied to the front cabinet 2 and the force applied so as to bend the front cabinet 2, preventing the front cabinet 2 from being distorted.

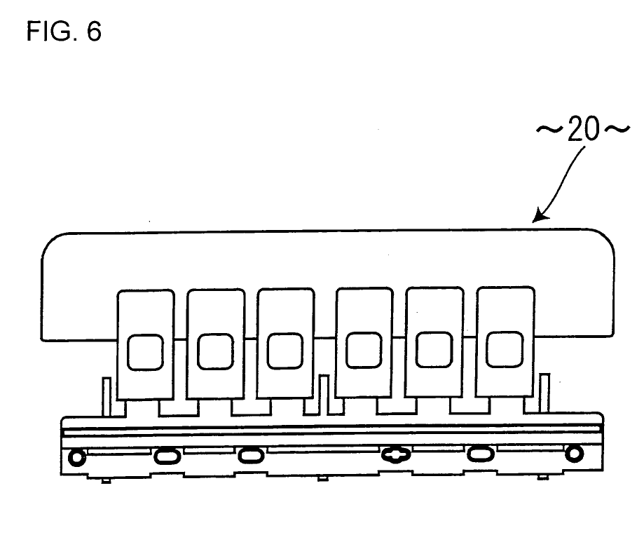

Reference number 20 shown in FIG. 6 denotes operation buttons, which enable various operations of the television receiver 1 attached to the mounting holes 12A of the boss sections 12 as described later. The operation buttons 20 are formed in the lower part of the front cabinet 2 as shown in FIG. 4 with one end of each operation button 20 inserted into an opening 31 formed by penetrating the front surface of the front cabinet 2 and formed at such positions as to allow the user of the television receiver 1 to easily operate the operation buttons 20 while watching an image displayed on the image display device 5.

Here, the operation buttons 20 will be further explained. As shown in FIG. 3 and FIG. 4, the operation buttons 20 which are a part of the television receiver 1 are attached by mounting means such as the mounting holes 12A of the boss sections 12 formed integral with the vertical inner wall surface 10 of the front cabinet 2 using screws 30 and the like. In such a mounting condition, as described above, one end of each operation button 20 penetrates the opening formed in the front cabinet 2 toward the outer side, making it possible to operate the operation buttons 20 from the outer side of the television receiver 1.

As shown above, according to the television receiver having a reinforcement/mounting dual-purpose structure 1 of the present embodiment, the boss sections 12 in which mounting holes 12A are formed to have the function as the reinforcement structure of the front cabinet 2 of the television receiver 1 and also to have the function as the mounting structure for additionally mounting parts and devices such as the operation buttons 20 in the television receiver 1. Therefore, since the boss sections 12 can serve for dual purposes as the reinforcement structure and mounting structure, when new improvements need to be added to the existing television receiver, it is possible to retrofit parts and devices to the vertical inner wall surface 10 of the television receiver and thereby provide the television receiver 1 with excellent versatility for consumers. Furthermore, in the television receiver 1 provided with the convex reinforcement ribs 11 formed integral with the flat vertical inner wall surface 10 placed upright in the front cabinet 2, which is a cabinet forming the outer shape of the television receiver 1, the cylindrical boss sections 12 are formed integral with the reinforcement ribs 11, which protrude from the vertical inner wall surface 10 and reinforce the reinforcement ribs 11, the mounting holes 12A are formed in the boss sections 12 so that parts such as operation buttons 20 provided for the television receiver 1 can be mounted, the boss sections 12 and reinforcement ribs 11 are used as the reinforcement structure of the cabinet when the operation buttons 20 are not attached to the cabinet, or the boss sections 12 are used as the mounting structure for attaching the operation buttons 20 when the operation buttons 20 are attached to the cabinet. Thus, the reinforcement ribs 11 and cylindrical boss sections 12 for further reinforcing the reinforcement ribs 11 are provided on the vertical inner wall surface 10 of the cabinet, and therefore, when, for example, the television receiver 1 is transported by a vehicle or when the television receiver 1 is mistakenly dropped onto the ground, it is possible to prevent the cabinet from bending, being broken or distorted. On the other hand, when parts and devices such as the operation buttons 20 need to be additionally mounted to the television receiver 1, the mounting holes 12A are formed in the boss sections 12 formed for further reinforcing the reinforcement ribs, and therefore, it is possible to mount these parts using mounting means such as screws or by fitting or engaging protrusions of the parts such as the operation button 20 with the mounting holes 12A, and even when parts need to be additionally attached to the television receiver 1 later, it is possible to attach the parts to the mounting holes 12A of the boss sections 12. Furthermore, when parts need to be additionally attached to the vertical inner wall surface 10 for the same purpose, it is possible to use the boss sections 12 in which the mounting holes 12A are formed as the mounting structure for mounting the parts such as the operation buttons 20 without the need to additionally mold or prepare a cabinet in which the mounting means such as the boss sections are molded integral with the vertical inner wall surface, and therefore, it is possible to provide the television receiver 1 having a reinforcement/mounting dual-purpose structure with excellent versatility. Furthermore, the parts in this embodiment are assumed to be the operation buttons 20 capable of performing various operations of the television receiver 1, which are attached to the mounting holes 12A of the boss sections 12 with one end of each operation button inserted into the opening 31 formed in the front cabinet 2 which is the cabinet, and therefore, when the operation buttons 20 need to be additionally attached to the television receiver 1, it is possible to attach the operation buttons 20 to these mounting holes 12A of the boss sections 12 formed on the vertical inner wall surface 10 of the cabinet by fitting or screwing the mounting means such as screws 30 into the mounting holes, and furthermore, since one end of each operation button 20 is inserted into the opening 31 formed in the cabinet, the user of the television receiver can easily operate the television receiver from the outer side. Here, “one end” of each operation button 20 refers to part of the entire operation button 20, and in this embodiment, it refers to a plurality of parts of the operation buttons 20 which protrude from the respective openings 31 shown in FIG. 1, from within the television receiver 1 outward. Furthermore, the operation buttons 20 can be mounted efficiently in a short time by screwing the general-purpose and easy-to-mount screws 30 into the mounting holes 12A formed in the boss sections 12. Furthermore, the cabinet is made up of the front cabinet 2 and the rear cabinet 3, wherein the front cabinet 2 is provided with the image display device 5 and the boss sections 12 and reinforcement ribs 11 are formed integral with the front cabinet 2. The image display device 5 is a main device among parts and devices constituting the television receiver and relatively heavier than other parts and devices. When such a heavy image display device 5 is mounted on the front cabinet 2, the weight of the image display device 5 is applied to the front cabinet 2 as a large load. In this case, since the boss sections 12 for reinforcing the reinforcement ribs 11 are formed on the vertical inner wall surface 10 of the front cabinet 2 in addition to the general reinforcement ribs 11, it is possible to reduce distortion of the front cabinet caused by the load produced when the front cabinet 2 is provided with the image display device 5. This embodiment uses the operation buttons 20 as parts attached to the mounting holes 12A of the boss sections 12, however, the parts are not particularly limited to such operation buttons 20 and for example, a device such as a hard disk drive can also be attached to the mounting holes 12A of the boss sections 12 instead of the operation button 20.

1. A television receiver provided with convex reinforcement ribs formed integral with a flat vertical inner wall surface of a cabinet which forms an outer shape of the television receiver, having a reinforcement/mounting dual-purpose structure comprising cylindrical boss sections protruding from the vertical inner wall surface integral with the reinforcement ribs formed for reinforcing the reinforcement ribs, and mounting holes formed in the boss sections so as to allow parts to be provided for the television receiver to be attached thereto, wherein when the parts are not attached to the cabinet, the boss sections and the reinforcement ribs are used as a reinforcement structure for the cabinet and when the parts are attached to the cabinet, the boss sections are used as a mounting structure to attach the parts.

2. The television receiver having a reinforcement/mounting dual-purpose structure according to claim 1, wherein the parts are operation buttons which are attached to the mounting holes of the boss sections with one end of each operation button inserted into an opening formed in the cabinet for enabling various operations of the television receiver.

3. The television receiver having a reinforcement/mounting dual-purpose structure according to claim 2, wherein the operation buttons are attached to the mounting holes formed in the boss sections by screwing screws into the mounting holes.

4. The television receiver having a reinforcement/mounting dual-purpose structure according to any one of claims 1 to 3, wherein the cabinet is made up of a front cabinet and a rear cabinet, in which the front cabinet is provided with an image display device and the boss sections and the reinforcement ribs are formed integral with the front cabinet.
